(19) United States
(12) Patent Application Publication
(10) Pub. No.: US 2017/0307001 A1
(43) Pub. Date: Oct. 26, 2017

(54) CAST-IN INSERTION MEMBER AND METHOD FOR PRODUCING THE SAME

(71) Applicants: HONDA MOTOR CO., LTD., Tokyo (JP); NIHON PLAST CO., LTD., Shizuoka (JP)

(72) Inventors: Yu NAKASHIMA, Saitama (JP); Takanori ONUMA, Saitama (JP); Tomoya MARUYAMA, Shizuoka (JP); Chiari SAITO, Shizuoka (JP); Tatsuhiko NAKAMURA, Shizuoka (JP)

(21) Appl. No.: 15/491,053

(22) Filed: Apr. 19, 2017

(30) Foreign Application Priority Data
Apr. 20, 2016 (JP) 2016-084796

(51) Int. Cl. F16B 17/00; B62D 29/00; F16B 9/00; B62D 25/14

(52) U.S. Cl. CPC F16B 17/006; F16B 9/00; B62D 25/145; B62D 29/007; B62D 29/008

(57) ABSTRACT

A cast-in insertion member out of which a core inserted during casting of cast portion can easily be pulled, and production method thereof are provided. Inside covering portion is formed to cover the interior of one end of pipe. During the casting, inside covering portion is interposed between the inner surface of the one end of pipe and the outer surface of the tip of the core put into pipe, so that a bite between pipe and the core by contraction of pipe due to molding shrinkage of cast portion can be prevented. Inside covering portion includes tapered surface on the side of recess, which gradually widens from the one end to the other end of pipe. After molding of cast portion, tapered surface making contact with the outer surface of the tip of the core gradually widens in the direction opposite to that of putting the core into pipe.

### CROSS REFERENCE TO RELATED APPLICATIONS

This application is entitled to and claims the benefit of Japanese Patent Application No. 2016-084796 filed on Apr. 20, 2016, the disclosure of which including the specification, drawings and abstract is incorporated herein by reference in its entirety.

### TECHNICAL FIELD

The present invention relates to a cast-in insertion member in which one end of an insert member is cast-in with a cast portion, and relates to a method for producing the cast-in insertion member.

### BACKGROUND ART

Conventional automobiles are each provided with an instrument panel at the front part of its vehicle interior, and a steering hanger beam that is long in the vehicle width direction is attached within the instrument panel. This steering hanger beam is for attaching to a vehicle body a steering shaft that is a manipulation device connected to a steering wheel provided at a driver's seat and an airbag device provided in the instrument panel, and the steering hanger beam is arranged between both right and left front pillars.

In some of such steering hanger beams, only a part of the steering hanger beam is made of steel and the remaining part thereof is made of a light metal material such as aluminum or magnesium for the purpose of weight reduction. In this case, welding between the steel and light metal parts takes time and labor, so that low-cost manufacturing cannot be achieved. Accordingly, a configuration in which the steel part is formed as an insert member and one end of the insert member is cast-in by the light metal is used (see e.g. Japanese Patent Application Laid-Open No. 2012-101266 (Page 5, FIGS. 3 and 4)).

### SUMMARY OF THE INVENTION

### Technical Problem

During production in the above manner, it is necessary to provide a core for being put into the insert member from the other end of the insert member in an attempt to prevent a molten metal from entering inside the insert member. In this case, since the inner surface of the insert member makes direct contact with the core, there is a risk that contraction of the insert member attendant upon solidification shrinkage of a cast portion causes a bite between the core and the insert member, and thus makes the core irremovable from the insert member.

The present invention has been implemented in view of such points, and an object of the present invention is to provide a cast-in insertion member from which a core put into an insert member during casting of a cast portion can easily be pulled out, and a method for producing the cast-in insertion member.

### Solutions to Problems

A cast-in insertion member according to a first aspect of the present invention includes a metal insert member formed in a tubular shape; and a metal cast portion that is cast around one end of the insert member. In the cast-in insertion member, the cast portion includes an outside covering portion covering an exterior of the one end of the insert member, and an inside covering portion covering an interior of the one end of the insert member, a recess surrounded by the inside covering portion is formed in the cast portion, and the inside covering portion includes a tapered surface on a side of the recess, the tapered surface being formed such that the recess surrounded by the tapered surface gradually widens from the first end to a second end of the insert member.

The cast-in insertion member according to a second aspect of the present invention is the cast-in insertion member according to the first aspect, in which the insert member is formed in such a manner as to include a hollow that passes through both of the ends.

The cast-in insertion member according to a third aspect of the present invention is the cast-in insertion member according to the first or second aspect, in which the insert member is formed wider at the one end than at the other end, the one end being cast-in by the cast portion.

A method for producing a cast-in insertion member according to a fourth aspect of the present invention is a method for producing a cast-in insertion member including a metal insert member formed in a tubular shape; and a metal cast portion that is cast around one end of the insert member, the method including providing a core including a tapered portion gradually narrowing toward a tip end of the core; inserting the one end of the insert member into a cavity in a mold in a state where the tip end of the core is put into the insert member from a other end of the insert member; and filling the cavity with a metal material to form the cast portion.

The method for producing a cast-in insertion member according to a fifth aspect of the present invention is the method for producing a cast-in insertion member according to the fourth aspect, in which the insert member is formed in such a manner as to include an a hollow that passes through both of the ends.

The method for producing a cast-in insertion member according to a sixth aspect of the present invention is the method for producing a cast-in insertion member according to the fourth or fifth aspect, in which the insert member is formed wider at the one end than at the other end; and when the core is put into the insert member, the core is placed such that the tapered portion is located inside the widened one end of the insert member.

### Advantageous Effects of Invention

According to the cast-in insertion member of the first aspect, an inside covering portion is formed in such a manner as to cover an interior of one end of an insert member. Accordingly, during casting of a cast portion, the inside covering portion is interposed between an inner surface of the one end of the insert member and an outer surface of a tip end of an core put into the insert member, and the inner surface of the one end of the insert member does not make direct contact with the outer surface of the tip end of the core, so that a bite between the insert member and the core to be caused by contraction of the insert member due to molding shrinkage of the cast portion can be prevented, and further, the core can easily be pulled out after molding of the cast portion since the inside covering portion includes, on the side of the recess surrounded by the inside covering portion, a tapered surface gradually widening from the one end to the other end of the insert member and after molding of the cast portion, the tapered surface of the inside covering portion that faces the recess and makes contact with the outer surface of the tip end of the core gradually widens in the direction opposite to the direction of putting the core into the pipe portion.

According to the cast-in insertion member of the second aspect, in addition to the advantageous effects exerted by the cast-in insertion member according to the first aspect, the insert member is formed in such a manner as to include a hollow that passes through both of the ends, so that the metal material can easily be poured into the insert member from the one end of the insert member to form the inside covering portion of the cast portion in a state where the core is put into the insert member from the other end of the insert member.

According to the cast-in insertion member of the third or fourth aspect, in addition to the advantageous effects exerted by the cast-in insertion member according to the first or second aspect, the insert member is formed wider at the one end than at the other end, the one end being cast-in by the cast portion, so that the thickness of the inside covering portion can be made greater and a bite between the insert member and the core to be caused by contraction of the insert member due to molding shrinkage of the cast portion can be more securely prevented.

According to the method for producing a cast-in insertion member of the fifth aspect, one end of an insert member is inserted into a cavity in a mold and the cavity is filled with a metal material to form a cast portion so as to form an inside covering portion in such a manner as to cover an interior of the one end of the insert member in a state where a tip end of a core including a tapered portion gradually narrowing toward the tip end is put into the insert member from the other end of the insert member. Accordingly, during casting of the cast portion, the inside covering portion is interposed between the inner surface of the one end of the insert member and the outer surface of the tip end of the core put into the insert member, and the inner surface of the one end of the insert member does not make direct contact with the outer surface of the tip end of the core, so that a bite between the insert member and the core to be caused by contraction of the insert member due to molding shrinkage of the cast portion can be prevented, and further, the core can easily be pulled out after molding of the cast portion since the inside covering portion includes, on a side of a recess surrounded by the inside covering portion, a tapered surface gradually widening from the one end to the other end of the insert member and after molding of the cast portion, the tapered surface of the inside covering portion that faces the recess and makes contact with the outer surface of the tip end of the core gradually widens in the direction opposite to the direction of putting the core into the pipe portion.

According to the method for producing a cast-in insertion member of the sixth aspect, in addition to the advantageous effects exerted by the method for producing a cast-in insertion member according to the fifth aspect, the insert member is formed in such a manner as to include a hollow that passes through both of the ends, so that the metal material can easily be poured into the insert member from the one end of the insert member to form the inside covering portion of the cast portion in a state where the core is put into the insert member from the other end of the insert member.

According to the method for producing a cast-in insertion member of the seventh or eighth aspect, in addition to the advantageous effects exerted by the method for producing a cast-in insertion member according to the fifth or sixth aspect, the insert member is formed wider at the one end than at the other end, the one end being cast-in by the cast portion; and when the core is put into the insert member, the core is placed such that the tapered portion is located inside the widened one end of the insert member, so that the thickness of the inside covering portion can be made greater and a bite between the insert member and the core to be caused by contraction of the insert member due to molding shrinkage of the cast portion can be more securely prevented.

### BRIEF DESCRIPTION OF DRAWINGS

FIG. 1A is a longitudinal sectional plan view of a cast-in insertion member according to Embodiment 1 of the present invention and FIG. 1B is a cross-sectional front view of the same cast-in insertion member;

FIG. 2 is a perspective view of a vehicle body component including the cast-in insertion member of Embodiment 1;

FIGS. 3A to 3D are longitudinal sectional plan views illustrating the cast-in insertion member of Embodiment 1 in the order of steps of a production method from FIG. 3A to 3D;

FIG. 4 is a longitudinal sectional plan view of a cast-in insertion member according to Embodiment 2 of the present invention;

FIGS. 5A to 5D are longitudinal sectional plan views illustrating the cast-in insertion member of Embodiment 2 in the order of steps of a production method from FIG. 5A to 5D;

FIG. 6 is a cross-sectional front view of a cast-in insertion member according to Embodiment 3 of the present invention; and

FIG. 7 is a cross-sectional front view of a cast-in insertion member according to Embodiment 4 of the present invention.

### DESCRIPTION OF EMBODIMENTS

A configuration according to Embodiment 1 of the present invention will be described below with reference to the drawings.

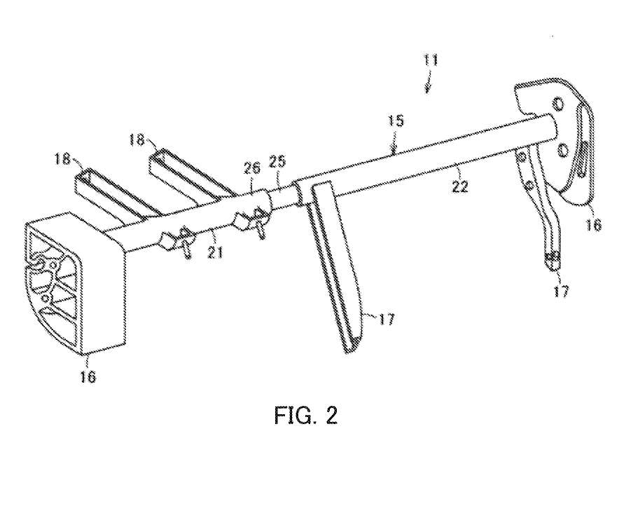

Reference numeral 11 in FIG. 2 designates a steering hanger beam that is a vehicle body component, the steering hanger beam 11 being also called, for example, as steering member and being arranged along the vehicle width direction inside an instrument panel (not illustrated) of the vehicle body.

In this respect, steering hanger beam 11 includes long beam body 15, side brackets 16, 16 provided at both ends of beam body 15, supporting brackets 17, 17 protruding downward from beam body 15, and steering supports 18, 18 protruding backward from beam body 15. In the meantime, steering hanger beam 11 of the present embodiment as illustrated is a steering hanger beam for a vehicle in which a driver's seat is located at the left side of the vehicle, so-called left-handled vehicle, but steering hanger beam 11 may also be configured for a right-handled vehicle by turning the configuration of the steering hanger beam for the left-handled vehicle from side to side. Directions such as up and down directions and right and left directions are hereinafter to be based on a vehicle which is traveling straight.

Beam body 15 is also called as main pipe, for example, and is formed in a substantially cylindrical shape. The structure of beam body 15 is such that first body part (body part on one end side) 21 as a cast-in insertion member that is located at one end of beam body 15 along the longitudinal direction (axial direction) is coaxially connected, for example, by welding to second body part (body part on the other end side) 22 as a connected part that is located on the other end of beam body 15 along the longitudinal direction (axial direction).

First body part 21 is formed in a substantially cylindrical shape by integrally molding pipe portion (tube) 25 as an insert member and cast portion (bracket member) 26.

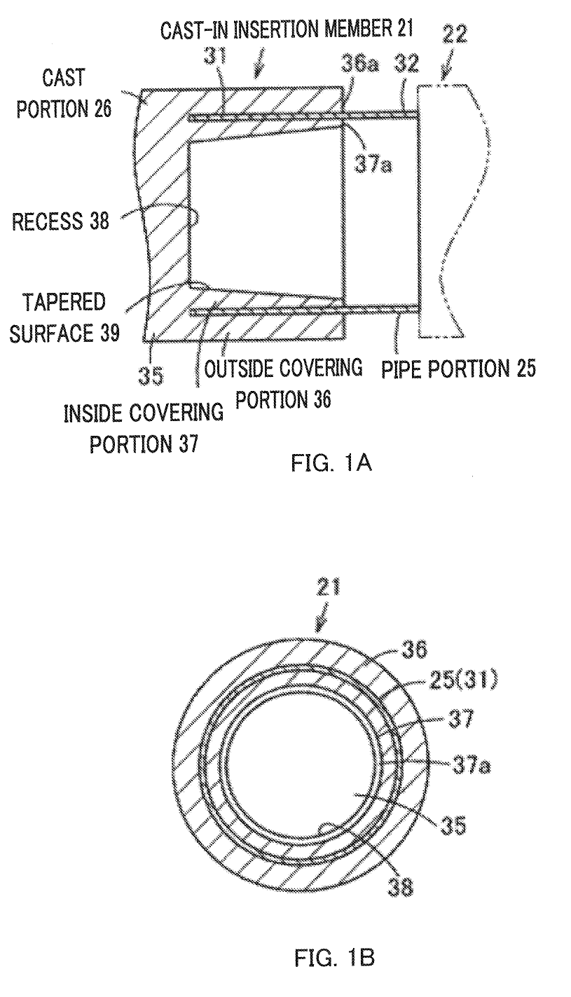

Pipe portion 25 is formed in a cylindrical shape from a metal material, steel in the present embodiment (FIG. 1B). As illustrated in FIG. 1A, pipe portion 25 is a straight tube which includes a hollow passing through both of its ends and has a substantially uniform diameter. In addition, the one end of pipe portion 25 is insert portion 31 to be covered with and embedded in cast portion 26, and the other end of pipe portion 25 is coupling portion 32 that is not covered with cast portion 26 and exposed, and is to be coupled, for example, by welding to one end of second body part 22.

Insert portion 31 is formed axially longer than coupling portion 32.

In contrast, cast portion 26 is molded in a cylindrical shape from a metal material different from the metal material of pipe portion 25, magnesium in the present embodiment that is a light metal material. Cast portion 26 is formed in a cylindrical shape having a greater outer diameter than pipe portion 25. In addition, cast portion 26 includes main cast portion 35, outside covering portion 36 that is formed at an end of main cast portion 35, inside covering portion 37, and recess 38.

Main cast portion 35 is formed, for example, in a long cylindrical shape. Main cast portion 35 couples outside covering portion 36 with inside covering portion 37. In addition, main cast portion 35 is provided with side bracket 16 (FIG. 2) on its tip end.

Outside covering portion 36 makes contact with the outer surface (outer peripheral surface) of insert portion 31 of pipe portion 25 and covers the exterior of insert portion 31. Outside covering portion 36 is formed in a tubular shape (cylindrical shape) having a substantially uniform outer diameter being greater than that of pipe portion 25, and is formed on the outer surface of insert portion 31 of pipe portion 25 in such a manner as to have a substantially uniform thickness.

Inside covering portion 37 makes contact with the inner surface (inner peripheral surface) of insert portion 31 of pipe portion 25, covers the interior of insert portion 31, and surrounds recess 38 at its periphery. That is, inside covering portion 37 is located on a side of insert portion 31 of pipe portion 25 facing away from outside covering portion 36, and insert portion 31 of pipe portion 25 is held radially between inside covering portion 37 and outside covering portion 36. In other words, insert portion 31 of pipe portion 25 is embedded in cast portion 26. In addition, inside covering portion 37 is formed in a tubular shape (cylindrical shape) having a thickness on insert portion 31 of pipe portion 25 that gradually increases along insert portion 31 from the other end to the one end of pipe portion 25. Accordingly, inside covering portion 37 includes tapered surface 39 on the side of recess 38 (in the interior), which gradually widens (expands in diameter) from the one end to the other end of pipe portion 25. In addition, end portion (end surface) 37a of inside covering portion 37 on a side opposite to main cast portion 35 (on a side of second body part 22) protrudes stepwise from the inner surface of pipe portion 25 toward the central axis. End portion 37a of inside covering portion 37 is substantially flush with end portion (end surface) 36a of outside covering portion 36 on a side opposite to main cast portion 35 (on a side of second body part 22), or is located more outwardly (on the side of second body part 22) than end portion 36a. That is, end portion 37a of inside covering portion 37 is located in the vicinity of end portion 36a of outside covering portion 36.

Recess 38 is located inward from insert portion 31 of pipe portion 25. Recess 38 is at its periphery surrounded by inside covering portion 37, and main cast portion 35 forms the bottom of recess 38.

With reference back to FIG. 2, second body part 22 is made of steel, for example, that is, the same material as the metal material of pipe portion 25 by casting in a substantially cylindrical shape.

Side brackets 16, 16 are for fixing steering hanger beam 11 between front pillars (not illustrated) of a vehicle body. In the meantime, in the present embodiment, one of side brackets 16, 16 is molded as one piece with first body part (cast portion 26 (main cast portion 35 (FIG. 1A))), and the other one is molded as one piece with second body part 22. Alternatively, side brackets 16, 16 may be molded separately from beam body 15 and may then be integrated with beam body 15 by welding or the like.

Supporting brackets 17 are for fixing steering hanger beam 11 to a vehicle body floor or the like. By way of example, in the present embodiment, one supporting bracket 17 is provided to second body part 22 at a central part along the longitudinal direction of beam body 15 in such a manner as to protrude, and the other supporting bracket 17 is provided to second body part 22 in the vicinity of side bracket 16 in such a manner as to protrude. Thus, each supporting bracket 17 is made of the same metal material as second body part 22. In this respect, supporting brackets 17 may be molded in advance as one piece with beam body 15 (second body part 22), or may be molded separately from beam body 15 (second body part 22) from a metal material that is the same as or different from the material of beam body 15 (second body part 22) and may then be integrated with beam body 15 (second body part 22) by welding or the like.

Steering supports 18, 18 are members located between a steering device and a member on the vehicle body side that is not illustrated, so as to support and fix the steering device to the member on the vehicle body side, the steering device including a steering wheel that is a wheel arranged at driver's seat, a steering shaft (steering column shaft) that is a manipulation device connected to the steering wheel, and the like. Steering supports 18, 18 is provided distantly from each other to first body part 21 (cast portion 26 (main cast portion 35 (FIG. 1A))) of beam body 15 in such a manner as to protrude. Accordingly, steering supports 18, 18 are made of the same material as cast portion 26. In the meantime, steering supports 18, 18 may be molded in advance as one piece with beam body 15 (first body part 21 (cast portion 26 (main cast portion 35 (FIG. 1A)))), or may be molded separately from beam body 15 (first body part 21 (cast portion 26 (main cast portion 35 (FIG. 1A)))) from a metal material that is the same as or different from the material of beam body 15 (first body part 21 (cast portion 26 (main cast portion 35 (FIG. 1A)))) and may then be integrated with beam body 15 (first body part 21 (cast portion 26 (main cast portion 35 (FIG. 1A)))) by welding or the like.

Next, a method for producing the steering hanger beam of above Embodiment 1 will be described.

In outline, steering hanger beam 11 is produced by separately forming first body part 21 and second body part 22, and then coupling an end of pipe portion 25 of first body part 21 to an end of second body part 22 by welding or the like.

In forming first body part 21, cylindrical pipe portion 25 is first formed in advance (forming step).

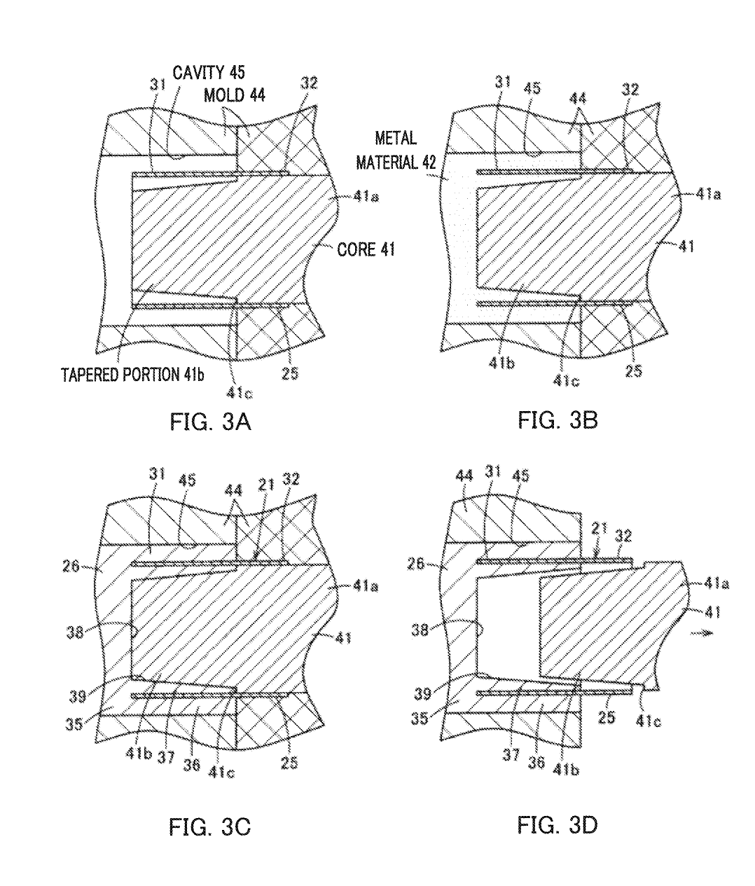

Core 41 as illustrated in FIG. 3A is subsequently provided and is put into pipe portion 25 from the other end of pipe portion 25, that is, from the side of coupling portion 32 (putting step).

In this respect, core 41 is for defining a shape of molten metal material 42 (FIG. 3B) within pipe portion 25, that is, shapes of inside covering portion 37 and recess 38 of cast portion 26 (FIG. 1A). Core 41 is formed from a material such as a metal having a thermal resistance, and has a shape that fits the inner surface of pipe portion 25, that is, includes, in one piece, core base end portion 41a formed in a columnar shape (cylindrical shape) having a substantially uniform diameter, tapered portion 41b formed by the tip end of core base end portion 41a, and stepped portion 41c formed between core base end portion 41a and tapered portion 41b.

Tapered portion 41b is formed in a columnar shape (cylindrical shape) gradually narrowing (reducing in diameter) from its base end to its tip end. Tapered portion 41b is thus frustoconical. Tapered portion 41b is a part for defining the inclination of tapered surface 39 (FIG. 1A) of inside covering portion 37 of cast portion 26.

Stepped portion 41c is an annular (ring-shaped) part formed as a surface radially outwardly extending from the base end of tapered portion 41b. Thus, core base end portion 41a and tapered portion 41b are continuous in a stepwise manner via stepped portion 41c.

Core 41 is put into pipe portion 25 such that core base end portion 41a makes contact with the inner surface of coupling portion 32 of pipe portion 25 and tapered portion 41b is located inside insert portion 31 of pipe portion 25. In this situation, tapered portion 41b is spaced apart from the inner surface of insert portion 31 of pipe portion 25 and the tip end of tapered portion 41b is located in such a manner as to be substantially flush with the tip end of pipe portion 25.

Next, molds 44, 44 are subsequently provided, and only insert portion 31 of pipe portion 25 into which core 41 is put is inserted into cavity 45 between molds 44, 44 (inserting step).

In this state, as illustrated in FIG. 3B, cavity 45 is filled with molten metal material (magnesium) 42 that is to form cast portion 26 (FIG. 1A) and is different from the metal material of pipe portion 25 (filling step). At this time, metal material 42 flows between the outer surface of pipe portion 25 and cavity 45, and between tapered portion 41b and stepped portion 41c of core 41 and insert portion 31 of pipe portion 25, and makes contact with the outer surface (outer peripheral surface) of tapered portion 41b, the end surface of stepped portion 41c of core 41, and the inner surface (inner peripheral surface) of pipe portion 25.

Metal material 42 is then cooled to be solidified, and as illustrated in FIG. 3C, cast portion 26 is formed in such a manner as to be cast around insert portion 31 of pipe portion 25 (solidifying step). At this stage, main cast portion 35 is formed at the tip end of pipe portion 25, outside covering portion 36 is formed on the outer surface of insert portion 31 of pipe portion 25, and inside covering portion 37 is formed on the inner surface of insert portion 31 of pipe portion 25. In the meantime, although insert portion 31 of pipe portion 25 tends to slightly contract (shrink) in the radial direction (direction toward the central axis) due to solidification shrinkage of metal material 42 (FIG. 3B), insert portion 31 is supported by inside covering portion 37 from the inner surface, so that contraction is suppressed.

Molds 44, 44 are subsequently opened, and as illustrated in FIG. 3D, core 41 is pulled out of pipe portion 25 from the other end (coupling portion 32) of pipe portion 25, so that recess 38 is formed (pulling step). According to the present embodiment, the one end (insert portion 31) of pipe portion 25 is inserted into cavity 45 in molds 44, 44 and cavity 45 is then filled with metal material 42 (FIG. 3B) to form cast portion 26 so as to form inside covering portion 37 in such a manner as to cover the interior of the one end (insert portion 31) of pipe portion 25 in a state where the tip end of core 41 including tapered portion 41b gradually narrowing toward the tip end is put into pipe portion 25 from the other end (the side of coupling portion 32). Accordingly, during casting of cast portion 26, inside covering portion 37 is interposed between the inner surface of the one end (insert portion 31) of pipe portion 25 and the outer surface of the tip end (tapered portion 41b) of core 41 put into pipe portion 25, and the inner surface of the one end (insert portion 31) of pipe portion 25 does not make direct contact with the outer surface of the tip end (tapered portion 41b) of core 41, so that a bite between pipe portion 25 and core 41 put into pipe portion 25 caused by contraction of pipe portion 25 due to molding shrinkage of cast portion 26 can be suppressed. In addition, after molding of cast portion 26, core 41 can easily be pulled out of pipe portion 25 since tapered surface 39 of inside covering portion 37 that faces recess 38 and makes contact with the outer surface of the tip end (tapered portion 41b) of core 41 gradually widens (expands in diameter) in the direction opposite to the direction of putting core 41 into pipe portion 25. Accordingly, first body part 21 can easily be detached from molds 44, 44.

Moreover, pipe portion 25 is formed in such a manner as to include a hollow that passes through both of its ends, so that metal material 42 (FIG. 3B) can easily be poured into pipe portion 25 from the one end of pipe portion 25 to form inside covering portion 37 of cast portion 26 in a state where core 41 is put into pipe portion 25 from the other end (coupling portion 32) of pipe portion 25.

Furthermore, the structures of molds 44, 44 and core 41 can be made simple, and easy insert casting is made possible.

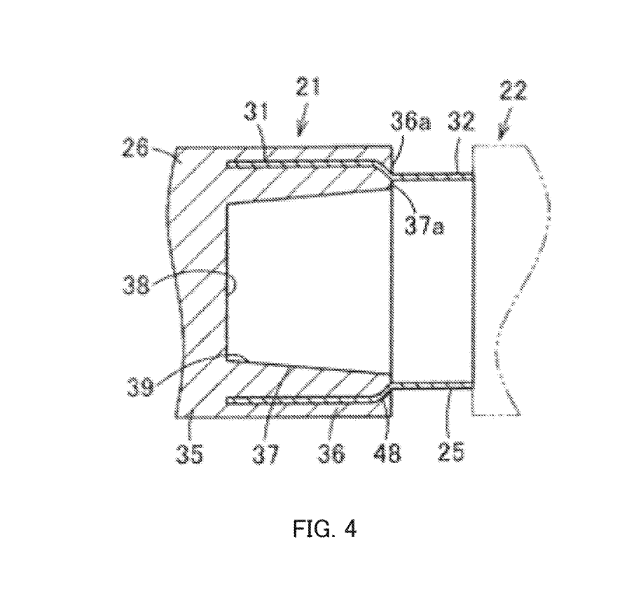

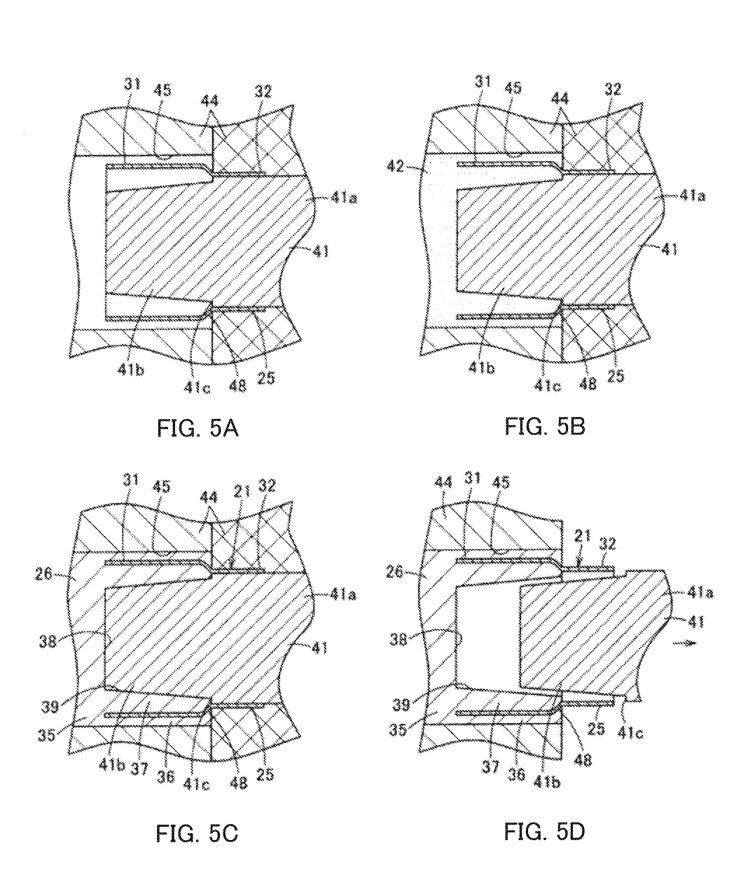

Next, Embodiment 2 will be described with reference to FIGS. 4 and 5. In this respect, the same components and actions as in above-described Embodiment 1 are provided with the same reference signs and the explanations thereof are omitted.

This embodiment includes a pipe portion in which pipe portion 25 of first body part 21 in above-described Embodiment 1 is modified to include between insert portion 31 and coupling portion 32 widening portion 48 that widens (expands in diameter) from coupling portion 32 to insert portion 31, as illustrated in FIG. 4. That is, pipe portion 25 is widened (expanded in diameter) in such a manner as to have wider outer and inner diameters at insert portion 31 as the one end than at coupling portion 32 as the other end. Insert portion 31 and coupling portion 32 are connected in a stepwise manner at the location of stepped portion 41c.

In the same manner as in above-described Embodiment 1, when first body part 21 is produced, cylindrical pipe portion 25 is first formed in advance (forming step), and core 41 as illustrated in FIG. 5A is subsequently put into pipe portion 25 from the other end of pipe portion 25, that is, from the side of coupling portion 32 (putting step). Core 41 is put into pipe portion 25 such that core base end portion 41a makes contact with the inner surface of coupling portion 32 of pipe portion 25 and tapered portion 41b is located inside insert portion 31 of pipe portion 25. In this state, core 41 is placed such that tapered portion 41b is spaced apart from the inner surface of insert portion 31 of pipe portion 25, the tip end of tapered portion 41b is located in such a manner as to be substantially flush with the tip end of pipe portion 25, and stepped portion 41c is located at the base end of widening portion 48.

Molds 44, 44 are subsequently provided, and only insert portion 31 of pipe portion 25 into which core 41 is put is inserted into cavity 45 between molds 44, 44 (inserting step).

In this state, as illustrated in FIG. 5B, cavity 45 is filled with molten metal material (magnesium) 42 that is different from the metal material of pipe portion 25 and is to form cast portion 26 (FIG. 4) (filling step). Metal material 42 is then cooled to be solidified, and as illustrated in FIG. 5C, cast portion 26 is formed in such a manner as to be cast around insert portion 31 of pipe portion 25 (solidifying step). Molds 44, 44 are subsequently opened, and as illustrated in FIG. 5D core 41 is pulled out of pipe portion 25 from the other end (coupling portion 32) of pipe portion 25 (pulling step).

In this case, the same working effects as those in above-described Embodiment 1 can be provided by the same configurations as those in above-described Embodiment 1, such as a configuration in which inside covering portion 37 is formed in such a manner as to cover the interior of the one end (insert portion 31) of pipe portion 25 and include tapered surface 39 that faces recess 38 and gradually widens (expands in diameter) in the direction opposite to the direction of putting core 41 into pipe portion 25, for example.

In addition, pipe portion 25 is formed wider at the one end (insert portion 31) than at the other end (coupling portion 32), the one end being cast-in by cast portion 26, and when core 41 is put into pipe portion 25, core 41 is placed such that tapered portion 41b is located inside the widened one end (insert portion 31) of pipe portion 25 As a result, the thickness of inside covering portion 37 can be made greater and a bite between pipe portion 25 and core 41 to be caused by contraction of pipe portion 25 due to molding shrinkage of cast portion 26 can be more securely prevented.

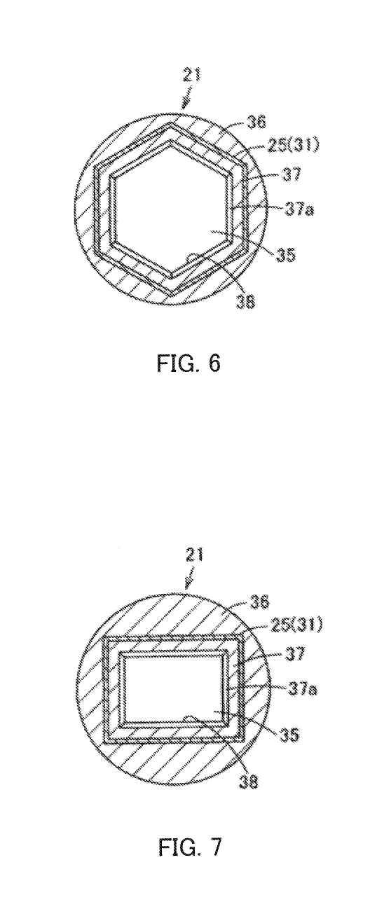

Alternatively, in each of the embodiments as described above, pipe portion 25 may, for example, be a hexagonal cylinder as in Embodiment 3 illustrated in FIG. 6, or may be a square cylinder as is Embodiment 4 illustrated in FIG. 7. That is, the cross-sectional shape of pipe portion 25 can be any polygon.

In addition, core 41 can also integrally be formed with mold 44.

Moreover, the configurations of each of the embodiments as described above are applicable not only to vehicle body components (steering hanger beam 11) but also to any other cast-in insertion members.

### INDUSTRIAL APPLICABILITY

The present invention can preferably be applied to at least part of a steering hanger beam, for example.

### REFERENCE SIGNS LIST

21 First body part as cast-in insertion member
25 Pipe portion as insert member
26 Cast portion
36 Outside covering portion
37 Inside covering portion
38 Recess
39 Tapered surface
41 Core
41b Tapered portion
42 Metal material
44 Mold
45 Cavity

1. An cast-in insertion member comprising:
a metal insert member formed in a tubular shape; and
a metal cast portion that is cast around a first end of the insert member, wherein:
the cast portion includes:
an outside covering portion covering an exterior of the first end of the insert member, and
an inside covering portion covering an interior of the first end of the insert member, wherein:
a recess surrounded by the inside covering portion is formed in the cast portion, and
the inside covering portion includes a tapered surface on a side of the recess, the tapered surface being formed such that the recess surrounded by the tapered surface gradually widens from the first end to a second end of the insert member.

2. The cast-in insertion member according to claim 1, wherein:
the insert member is formed in such a manner as to include a hollow that passes through the first and the second ends.

3. The cast-in insertion member according to claim 1, wherein:
the insert member is formed wider at the first end than at the second end, the first end being cast-in by the cast portion.

4. The cast-in insertion member according to claim 2, wherein:
the insert member is formed wider at the first end than at the second end, the first end being cast-in by the cast portion.

5. A method for producing a cast-in insertion member provided with a metal insert member formed in a tubular shape and a metal cast portion that is cast around a first end of the insert member, the method comprising:
providing a core including a tapered portion gradually narrowing toward a tip end of the core;
inserting the first end of the insert member into a cavity in a mold in a state where the tip end of the core is put into the insert member from a second end of the insert member; and
filling the cavity with a metal material to form the cast portion.

6. The method for producing a cast-in insertion member according to claim 5, wherein:
the insert member is formed in such a manner as to include a hollow that passes through the first and the second ends.

7. The method for producing a cast-in insertion member according to claim 5, wherein:
the insert member is formed wider at the first end than at the second end; and
when the core is put into the insert member, the core is placed such that the tapered portion is located inside the widened first end of the insert member.

8. The method for producing a cast-in insertion member according to claim 6, wherein:
the insert member is formed wider at the first end than at the second end; and
when the core is put into the insert member, the core is placed such that the tapered portion is located inside the widened first end of the insert member.
